(19) United States
(12) Patent Application Publication
(10) Pub. No.: US 2023/0034537 A1
(43) Pub. Date: Feb. 2, 2023

(54) CONVERSION APPARATUS AND A SCREEN COMPRISING THEREOF

(71) Applicant: BILKENT UNIVERSITESI (UNAM) ULUSAL NANOTEKNOLOJI ARASTIRMA MERKEZI, Ankara (TR)

(72) Inventors: Hilmi Volkan DEMIR, Ankara (TR); Emre UNAL, Ankara (TR)

(73) Assignee: BILKENT UNIVERSITESI (UNAM) ULUSAL NANOTEKNOLOJI ARASTIRMA MERKEZI, Ankara (TR)

(21) Appl. No.: 17/784,496

(22) PCT Filed: Dec. 22, 2020
(86) PCT No.: PCT/TR2020/051352

§ 371 Date: Jun. 10, 2022

(30) Foreign Application Priority Data
Dec. 25, 2019 (TR) 2019/21481

(51) Int. Cl. G02F 2/02

(52) U.S. Cl. CPC G02F 2/02; G02F 2202/36

(57) ABSTRACT

The present invention relates to a conversion apparatus (1) for converting an image output on screens from a visible wavelength range into an infrared wavelength range, and a screen (A) comprising thereof.

### TECHNICAL FIELD

The present invention relates to a conversion apparatus for converting an image output on screens from a visible wavelength range into an infrared wavelength range, and a screen comprising thereof.

### BACKGROUND OF THE INVENTION

Scientists who carry out research and observations on astronomy usually perform study in dark areas and they need this darkness to be maintained until the end of their study. However, they are often in need of electronic devices for the data which are obtained during the studies being performed, and they have difficulty in their studies because of the lights emitting from these devices. Therefore, there is need for an apparatus which ensures that devices emitting light around in cases where darkness is required have an image that is like a dark surface externally but enables staff to see data by means of similar equipment such as night vision binoculars, and which makes it easier for scientists to complete their study without the need to emit any light around.

The United States patent document no. US2011013253, an application in the state of the art, discloses an integrated film which includes a plasmonic layer created by being patterned. This film has a feature of down shifting and up shifting the incoming wavelength. Because of this feature, the wavelength converting film can be used in night vision devices. However, the film included in the apparatus that we applied for does not have a plasmonic layer by being patterned. In addition, the apparatus provides the possibility to be used with night vision devices, not in night vision devices.

### SUMMARY OF THE INVENTION

An objective of the present invention is to realize a conversion apparatus which converts image output on screens from a visible wavelength range into an infrared wavelength range, and a screen comprising thereof.

Another objective of the present invention is to realize a conversion apparatus which prevents emission of light around by enclosing the light in the visible wavelength upon being inserted on screens in dark work environments and enables to see the image of the screen that is converted into an infrared wavelength by means of suitable equipment, and a screen comprising thereof.

### DETAILED DESCRIPTION OF THE INVENTION

“A Conversion Apparatus and a Screen Comprising Thereof” realized to fulfil the objectives of the present invention is shown in the figures attached, in which:

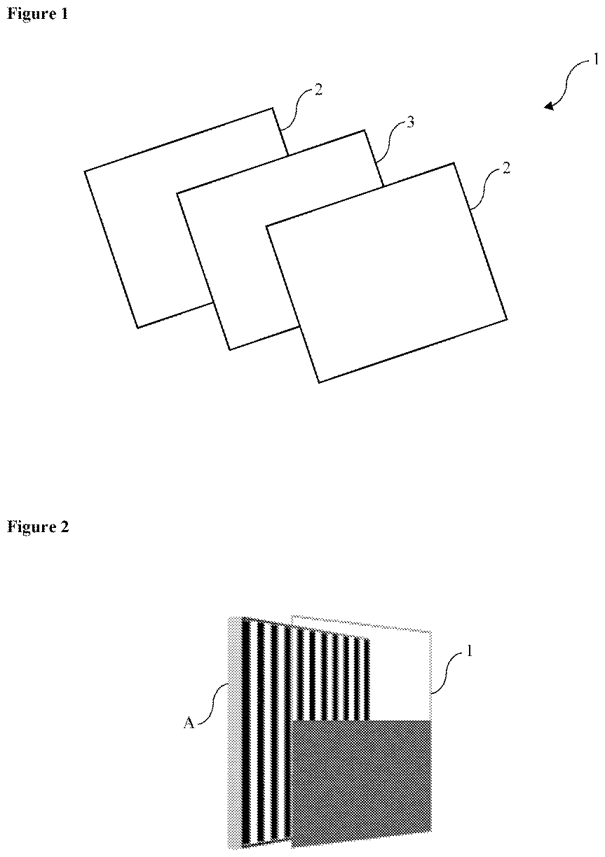

FIG. 1 is an exploded view of the inventive conversion apparatus.

FIG. 2 is a view of the inventive conversion apparatus in front of a screen with image output wherein vertical lines are included such that its upper part is cut.

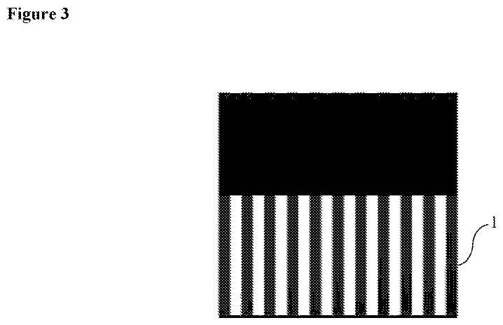

FIG. 3 is a view seen when the conversion apparatus placed in front of the inventive screen is viewed by IR night vision binoculars across.

The components illustrated in the figures are individually numbered, where the numbers refer to the following:
1. Conversion Apparatus
2. Body
3. Film

A: Screen

The inventive conversion apparatus (1) for converting an image output on screens (A) from a visible wavelength range into an infrared wavelength range comprises:
at least one body (2); and
at least one film (3) which is inserted into the body (2) and configured to convert the wavelength of the light in the visible wavelength range arriving on it, into infrared.

The body (2) included in the inventive conversion apparatus (1) has a planar form has a planar form such that it will cover both surfaces of the film (3). In a preferred embodiment, the body (2) is made of a glass or transparent material. In another preferred embodiment, the body (2) is made of a high transparency PET-type material with folding characteristic. The body (2) is configured to be inserted onto a screen (A) having a monitor, an indicator or a signal light.

The film (3) included in the inventive conversion apparatus (1) comprises one or more nanoparticles for radiation in one or more different wavelength ranges by absorbing photons in visible wavelength. In a preferred embodiment, the film (3) is obtained by turning PbS core or PbS/CdS nanoparticles into a thin form like paper by using acrylic-based polymers.

The inventive conversion apparatus (1) enables the screen (A) to look dark when it is inserted onto the screen (A) displaying an image in a visible wavelength range, by enclosing the light. Besides, the conversion apparatus (1) converts an image exiting from the screen (A)—that is in a visible wavelength range— into an infrared wavelength range and then enables scientists studying on astronomy to see an image converted into an visible wavelength range, easily and to complete their studies comfortably by means of night vision binoculars although no light is emitted out from screens in dark working environments they need. The said conversion apparatus (1) can be placed in front of the screen (A), and it can be integrated to the screen (A) in software or by photo absorption as well.

In one embodiment of the invention, the conversion apparatus (1) integrated to the screen (A) in software ensures that part of adjacent pixels are aligned with the film (3) consecutively and fixed, upon the film (3) is patterned on monochrome monitor screens (A). Thereby, operation of a monitor can be ensured in an IR area by use of only aligned pixels in software or only in a visible area by use of only non-aligned pixels.

In another embodiment of the invention, the conversion apparatus (1) integrated to the screen (A) by photo absorption is realized by ensuring that the film (3) absorbs only the requested wavelengths. Due to the fact that one colour (a certain wavelength range) of two-coloured LED signal lamp passes through the film (3) without being absorbed, it is visible to the human eye at a visible wavelength whereas it is ensured that the other colour thereof (a certain wavelength range) is absorbed and then used upon being converted into an infrared wavelength.

In addition, the present invention also relates to a screen (A) comprising the above-stated conversion apparatus (1).

Within these basic concepts; it is possible to develop various embodiments of the inventive conversion apparatus (1); the invention cannot be limited to examples disclosed herein and it is essentially according to claims.

1. A conversion apparatus (1) for converting an image output on screens (A) from a visible wavelength range into an infrared wavelength range comprising:
at least one body (2); and
at least one film (3) which is inserted into the body (2) and configured to convert the wavelength of the light in the visible wavelength range arriving on it, into infrared.

2. A conversion apparatus (1) according to claim 1; characterized by the body (2) which has a planar form has a planar form such that it will cover both surfaces of the film (3).

3. A conversion apparatus (1) according to claim 1; characterized by the body (2) which is made of a glass or transparent material.

4. A conversion apparatus (1) according to claim 1; characterized by the body (2) which is made of a high transparency PET-type material with folding characteristic.

5. A conversion apparatus (1) according to claim 1; characterized by the body (2) which is configured to be inserted onto a screen (A) having a monitor, an indicator or a signal light.

6. A conversion apparatus (1) according to claim 1; characterized by the film (3) which comprises one or more nanoparticles for radiation in one or more different wavelength ranges by absorbing photons in visible wavelength.

7. A conversion apparatus (1) claim 6; characterized by the film (3) which is obtained by turning PbS core or PbS/CdS nanoparticles into a thin form like paper by using acrylic-based polymers.

8. A screen (A) comprising a conversion apparatus (1) according to claim 1.
